(19) United States
(12) Patent Application Publication
(10) Pub. No.: US 2007/0051585 A1
(43) Pub. Date: Mar. 8, 2007

(54) Apparatus and method for guiding and sorting packages and containers

(76) Inventors: Darius Melton Scott, Baltimore, MD (US); Howard Eisenberg, Woodbine, MD (US)

Correspondence Address: WILEY, REIN & FIELDING, LLP;ATTN: PATENT ADMINISTRATION, 1776 K. STREET N.W., WASHINGTON, DC, 20006, US

(21) Appl. No.: 11/517,245

(22) Filed: Sep. 8, 2006

Related U.S. Application Data
(60) Provisional application No. 60/714,867, filed on Sep. 8, 2005.

(51) Int. Cl. B65G 47/46

(52) U.S. Cl. 198/370.07

(57) ABSTRACT

The invention comprises a conveyor or sorting system capable of providing multiple divert steps that effectively sort or sequence objects into a desired order on a main conveyor surface. The divert steps or processes involve a divert area active at a divert point along the main conveyor axis. In particular, the invention employs an apparatus or steps in a sorting operation to minimize or reduce the percentage of objects or containers that fall from or jam on the main conveyor by using the bi-directional divert apparatus and divert guides. The apparatus and methods can more accurately sort collections of containers or objects into a desired sequence, for example, as used in mail or parcel delivery systems.

### REFERENCE TO RELATED APPLICATIONS

This application claims priority benefit of U.S. Provisional Application 60/714,867, filed Sep. 8, 2005, the entire contents of which are hereby incorporated by reference.

### FIELD OF THE INVENTION AND INTRODUCTION

The invention relates to an apparatus for guiding and sorting a set of packages or containers into a desired series. The invention is particularly useful in mail or package processing prior to shipment or delivery. By accurately sorting packages or containers into a desired series, managing the collection or distribution system can more efficiently rely on the location in a series rather than numerical identifiers or coding for each package or container.

### RELEVANCE AND BACKGROUND TO THE INVENTION

The processing, sorting and delivering performed in mail or delivery operations have undergone considerable automation in the last decade. However, certain aspects require further innovation. As noted in Jarrah et al., Eur. J. Operational Res. 63 (1992) 192-206, the sequencing or casing of mail prior to delivery entails a particularly cumbersome task. Typically, mail is sorted into delivery regions and the carriers case the containers for appropriate delivery sites and bundle mail by hand prior to delivery. This process is slow and prone to errors. There is particular interest in automating these tasks to reduce processing time and increase volume. The United States Postal Service (USPS) has proposed sorting the sequence of mail containers into the sequence they are intended to be delivered on a delivery route. Delivery stops and/or personnel or vehicles can be correspondingly ordered so that the process of moving mail from a post office to a carrier or delivery truck to a delivery site is expedited.

Various conveying devices and apparatus have been used and proposed for processing the flow of packages or mail in a sorting or distribution center. Automated processes for sorting mail packages and containers of mail include those referring to diverters from the main conveyor, which allow containers to be sorted. Typically, a diverting element contacts the container and pushes the container lateral to the conveying axis form a divert zone or point into a divert area. In some concepts, a bi-directional diverting means can utilize a container-stopping device with a pushing plate or surface. Once stopped, the container is pushed to one side or another and later pushed back into the main conveyor. A conveyor can also include an apparatus to pick up and move a package or box laterally to divert it.

In practice, these approaches lack a positive tracking mechanism on the main conveyor axis or a positive container skew- or orientation-correcting mechanism on the divert process, the lack of each or both of which makes the apparatus prone to errors in the accuracy of the sorting or in jamming. These approaches may also lack the ability to divert to two sides at the same point, which can dramatically reduce space requirements.

Thus, there is a need in the art for automated mail and package sorting methods, mechanisms, and apparatus that operate effectively and efficiently in a high volume system.

### SUMMARY OF THE INVENTION

In a general aspect, the invention encompasses a device, apparatus, or method for accurately sorting objects into a desired series or sequence, such as any of a variety of containers like flat mail trays, totes, cartons, boxes, or parcels. Once sorted into a desired sequence, the objects or containers can be more efficiently shipped or delivered. While mail sorting or flats sorting methods and devices for implementing these methods are a specifically preferred aspect of the invention, the concepts and aspects of the invention described here can be used in other systems where a conveyor is used.

A particularly troublesome problem in many or all of the proposed automation solutions is the propensity of a flats container or tray to fall off of a main conveyor or become jammed during the activity used to sort or divert. As understood in the art, divert or diverting is a term referring to a process to move (temporarily or permanently) an object out of the flow of a main conveyor and optionally return it at a different, desired position in a sequence of objects on the main conveyor. Multiple divert steps can be used to effectively sort or sequence objects into a desired order on the main conveyor surface. Thus, in a general aspect, the invention comprises improving the divert process or steps in a sorting operation to minimize or reduce the percentage of containers that fall from or jam on the main conveyor by using the bi-directional divert apparatus and methods and divert guides described here.

In a particular aspect, the invention may be used for sorting United States Postal Service mail trays of various sizes from a single file, initial sequence on a main conveyor into a desired sorted sequence on the conveyor. Sorting, as used herein, refers to at least a single operation of moving one tray into a divert area and returning it to a different point on, or at a different point in the sequence of trays on, a main conveyor surface. While motorized rollers are used in the particular examples later, belts, combinations of belts and rollers, and combinations of motorized areas and free-sliding or free-rolling areas and any other conveyor methods known in the art can be selected for use in any of the aspects of this invention. In general, the sorting process is computer controlled through indicators or sort labels on each tray, as known in the art. Bar code labels are especially useful for this purpose and can be detected by electrooptic or other industrial optic devices known in the art.

The sort step or sorting method utilizes bi-directional, lateral divert guides to direct or push trays into a divert area, one on each side of the main conveyor, from a divert zone or divert point on the surface of the conveyor. A particular tray entering the divert point is detected by a sensor, the conveyor is generally stopped in response to the detected tray, divert guides are activated to divert the tray by pushing to one of the lateral divert areas or conveyors. The divert area can comprise side rails to direct the tray of a uniform size into a central region of the divert area to reduce skewing or jamming. The surface below the tray can then roll or move to return the tray into a new point in the sequence of trays on the conveyor. During the return process or step, the bi-directional divert guides can again be used, at the appropriate side, to stop the returning tray in the middle of the main conveyor. Both divert guides can then be raised and placed in the main conveying position, where the divert guides prevent the trays from falling off the main conveyor or turning and jamming on the conveyor. This process can be repeated several times and with several bi-directional divert apparatus in a series to re-sequence the order of trays on a main conveyor. As noted below, one or more of the divert areas can also serve as final sorting points for particular trays, if desired. The divert areas can also be linked to other conveyors to move the sorted trays.

In another particular aspect, the invention may be used for diverting United States Postal Service mail trays of various sizes from a single file on a main conveyor into lateral conveyors, one on each side, for later pick up. This includes a tray entering the divert point or zone, a sensor to detect a desired tray, divert guides activating for desired trays to divert them by pushing them to one of the lateral divert areas or conveyors.

In aspects of the invention where an object is maneuvered into a lateral divert area, which can be 90 degrees from the conveyor axis or path or some other angle, the contact with the object and the force exerted to push or maneuver the object should ideally be calibrated to avoid tilting, skewing, or falls off the main conveyor surface or the divert area surface. The point of contact, or points of contact, between the diverting device and the object can also be adjusted and calibrated. In addition, the position of the object can be monitored so that the main conveyor resumes conveying objects along the axis or path only after an object is free of the main conveyor surface. The preferred embodiment will be calibrated and adapted to sort or divert USPS mail trays of various weights and sizes from a single file line on the main conveyor onto lateral divert areas, for ultimate delivery or shipping. The USPS trays can be open or have lids and can be in a number of different configurations.

For the USPS, the main conveyor process moves trays in a defined path, which may be a straight line or other or curved lines, until they exit the conveyor. To protect the trays from falling off the main conveyor side guards are typically used. The divert guides in the bi-directional divert apparatus of the invention are intended to or are capable of being used in conjunction with the main conveyor side guards and the divert guides can function to operate so that the trays are protected in the same manner through the divert point in the bi-directional divert apparatus as through the main conveying areas. Then, when the divert action is activated, generally through a computer controlled detection process, the conveyor stops the tray at the divert point, the divert guides are activated to push the tray to one divert area or the other, and the tray is moved off of the main conveyor path. The divert guides then resume their position for protecting trays as they move through the main conveyor path. Throughout this disclosure, we refer to a main conveyor path, a conveyor axis, or conveyor path as essentially the same thing, the direction that objects are being moved over the main conveying function of the system. However, various points along the main conveyor path may be physically part of the main conveyor or part of the lateral divert apparatus of the invention.

The invention thus comprises a conveyor system, method, and device for sorting mail trays, where the trays have a detectable ID or sort label for a desired delivery site or sorting area. Preferred examples include a conveyor having a plurality of rollers for moving trays along a conveying axis or path that is formed by the conveyor rollers and include one or more bi-directional lateral divert apparatus capable of being combined or linked with the conveying axis or path and the rollers of the axis or path. The bi-directional lateral divert apparatus itself comprises divert areas on each side of the conveyor axis or path, wherein the divert areas have rollers or moving receivers for receiving a diverted tray from the conveyor axis or path depending upon the information on the ID or sort label. The divert apparatus also includes retractable divert guides on either side of the conveyor axis or path, at a point referred to as a divert point. The divert guides are capable of pushing or moving a tray toward or into a desired divert area. The divert guides are generally disposed or operate so that as at least one divert guide, which is initially on one side of the conveyor axis or path or retracted below the conveyor path on one side or the other, is positioned on one side of the conveyor path and pushes the tray, the divert guide or guides on the other side of the conveyor axis or path retract under the plane of the rolling surface of the conveyor axis or path and allow the tray to traverse into a divert area. The divert area can contain a moveable surface, rollers, or movers to return the tray to the conveyor axis or path. The divert guides can function to push the tray into substantially the center of the divert area and/or can function to position the tray being returned to the conveyor axis or path in substantially the center of the conveyor axis or path.

The conveyor system, method or device can be operated with a plurality of bi-directional lateral divert apparatus.

The conveyor system, method or device can also employ photoelectric sensor(s) to detect the position of a tray on the conveyor axis or path or anywhere on the conveyor system. Any one of many available detection technologies and/or sensor technologies can be selected and adapted for use.

In addition, the conveyor system, method or device can be used in conjunction with a master control computer to monitor the movement of trays, to determine whether a tray contains an ID or sort label for a desired divert area, and/or detect incorrect sorting or other errors in the conveying process. One of skill in the art is familiar with many available computer systems, software, and master control computers that can be selected and adapted for use with the invention. Generally, the master control computer controls the motors for rollers or surfaces of the main conveyor as well as the rollers, surfaces, and divert guides for the bi-directional lateral divert apparatus.

The invention is also intended to be used in high volume sorting operations, where the intended sorting rate is approximately 40,000 pieces of mail per hour or more for a single pass operation, or 16,000 pieces of mail per hour or more for a multi-pass operation. The number of trays, totes, cartons, boxes, or parcels sorted per hour in a two-pass operation is about 1,600 per hour, where the two-pass operation involves a first sorting and storage process and a second sorting process prior to final dispatch. Of course, one or multiple sorting/storage/dispatch processes can occur on any collection of containers or objects.

In particular embodiments, multiple staging areas for placing and storing containers or objects on the conveyor system during a sorting process can be used, so that, for example, two or more staging areas be used on one or both ends of the main conveyor line. The use of multiple staging areas on one or both ends of the main conveyor provides faster sorting of collections of containers or objects within the same conveyor system area and/or reduces the length of conveyor surfaces required to effectively sort a collections of containers or objects.

### BRIEF DESCRIPTION OF THE FIGURES

The invention can be more clearly shown by the examples of the figures, which should not be taken as a limitation to the scope of the invention in any way, and where:

FIGS. 1-8 shows an exemplary sequence of a container being diverted from a main conveyor and returned to the main conveyor from a divert area. The object or container of flats, for example, is labeled (1) and is shown in FIG. 1 on main conveyor rollers (2). Moving divert guides (3) and (4) are actuated when a sorting or divert action is desired and the presence of a guide on either side of the main conveyor allows diverting to occur on either lateral side, right or left, of the main conveyor axis or direction of the flow of objects. The guides on each side also keep the container (1) in the center of the conveyor rollers. The divert area rollers (5) are actuated to return the object or container back into the main conveyor flow, if desired. Each divert area may also function as a final sorting point or staging area. The divert point of the main conveyor in FIG. 1 is the area where container (1) is located and sensors or electrooptical devices can be used to locate the container or actuate the divert guides (3) or (4) at the desired time.

FIG. 2 shows the moving divert guides (3) and (4) extended as in FIG. 1.

FIG. 3 shows a divert process at approximately mid-point. After a signal or ode activation indicates that the object or container (1) at the divert point is to be diverted, such as the signal from a fiber optic eye, the moving divert guides (3) and (4) push the container (1) in the desired direction, left or right. Generally, a right angle between the main conveyor and the lateral divert areas is preferred, but a right angle is not necessary. Divert area guardrails (7) are intended to maintain the container (1) in the center of the divert area and its rollers. In the case of FIG. 3, divert guide (3) is shown pushing the container (1). Divert guide (4) moves in concert with divert guide (3) by the wheels (9) and wheel tracks (10) under the divert area. Divert guide (4) is folded below the divert area and not shown. In FIG. 3, the divert guide (3) as at the fully pushed point.

FIG. 4 shows the same time point in the divert process as in FIG. 3, except that container (1) is not shown.

FIG. 5 shows the container (1) returning to the main conveyor through the action of divert area rollers (5) and (6). Divert guide (3) here stops the progress of container (1) at a point in the center of main conveyor. Main conveyor rollers (2) can then move container (1) into flow of conveyor or to another divert point.

FIG. 6 shows the same time point in the divert process as FIG. 5, but container (1) is not shown. In FIG. 6, the second divert guide (4) can be seen at a point below the conveyor surface so that container (1) moves over it. Wheel (9) is at a different point in wheel track (10) compared to FIG. 3.

FIGS. 7 and 8 show the divert guide (3) at the beginning of its pushing action.

FIGS. 9-11 show additional embodiments and views of the divert areas or that connect to a main conveyor line or path.

FIG. 9A is a top view with a container (1) shown in the middle of the divert point. Divert guides (3) are located on either side of the divert point and divert rollers (5) move the object further down into divert area.

FIG. 9B is a side view, where divert area side guards (7) are integral to a divert area roller housing and have sensors (11) attached, such as electrooptic sensors. Below the divert point in the center is the mechanism for retracting the divert guides and moving one or the other into a diverting position above the plane of the rollers of the main conveyor.

FIG. 10A is another side view showing the housing for the retracting mechanism (12) and sensors (11) attached on outer surface of side divert guide housing.

FIG. 10B shows a view on end, looking down a side divert area to a container (1) on the main conveyor. Sensors (11) are also visible.

FIG. 11 is a cut-away view of the rollers of the side divert areas (6) and belts (13) that can connect rollers so that desired divert rollers on one side move simultaneously. Again, sensors (11) are shown.

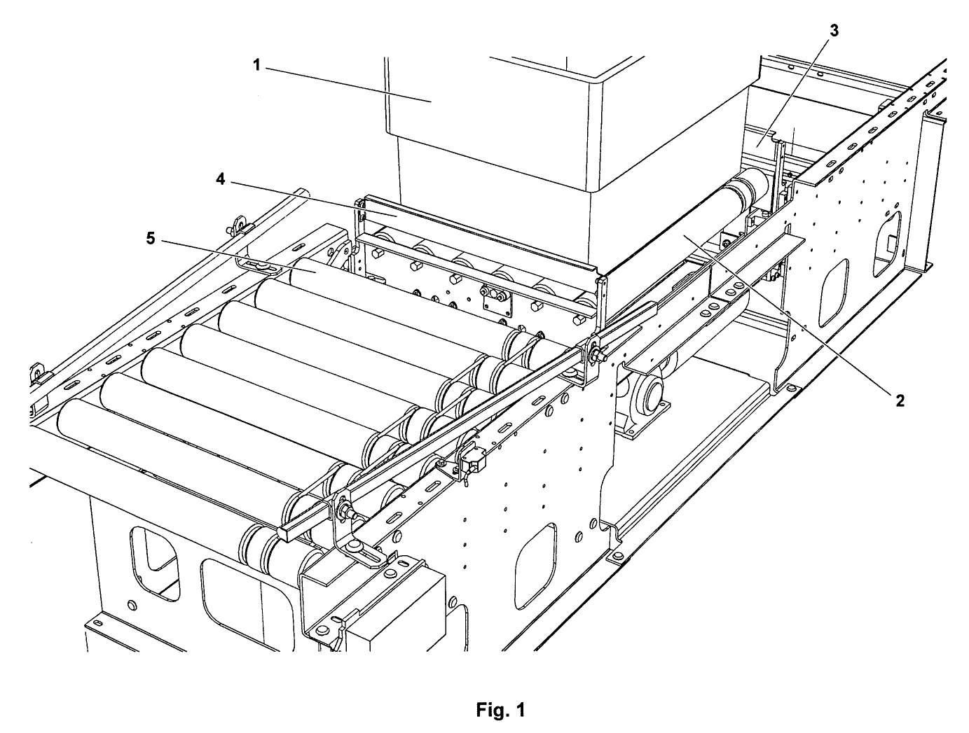

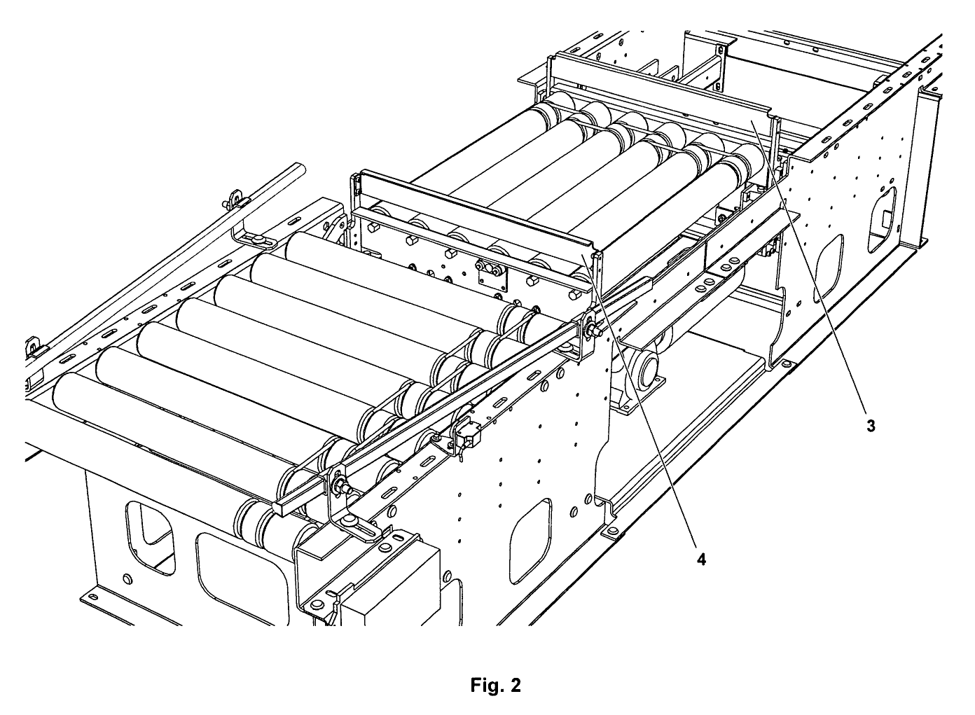

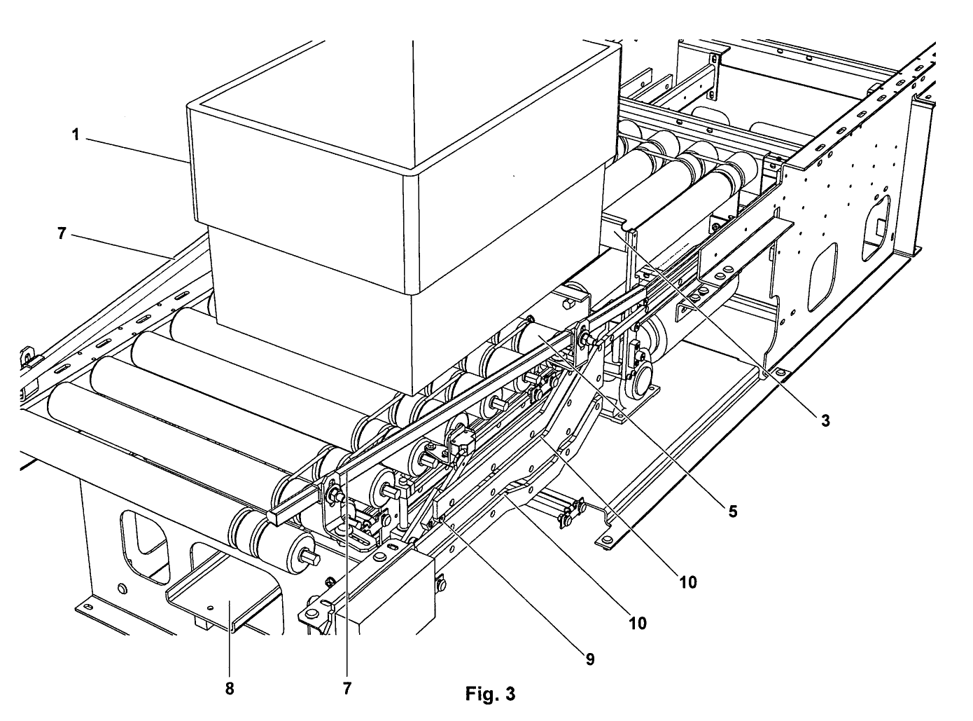

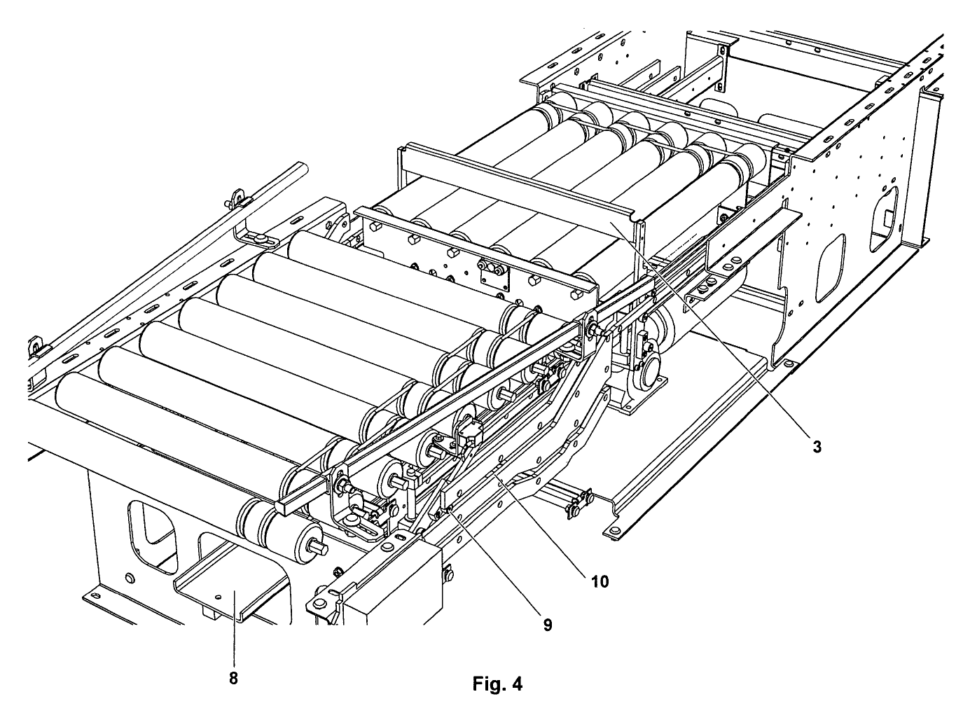

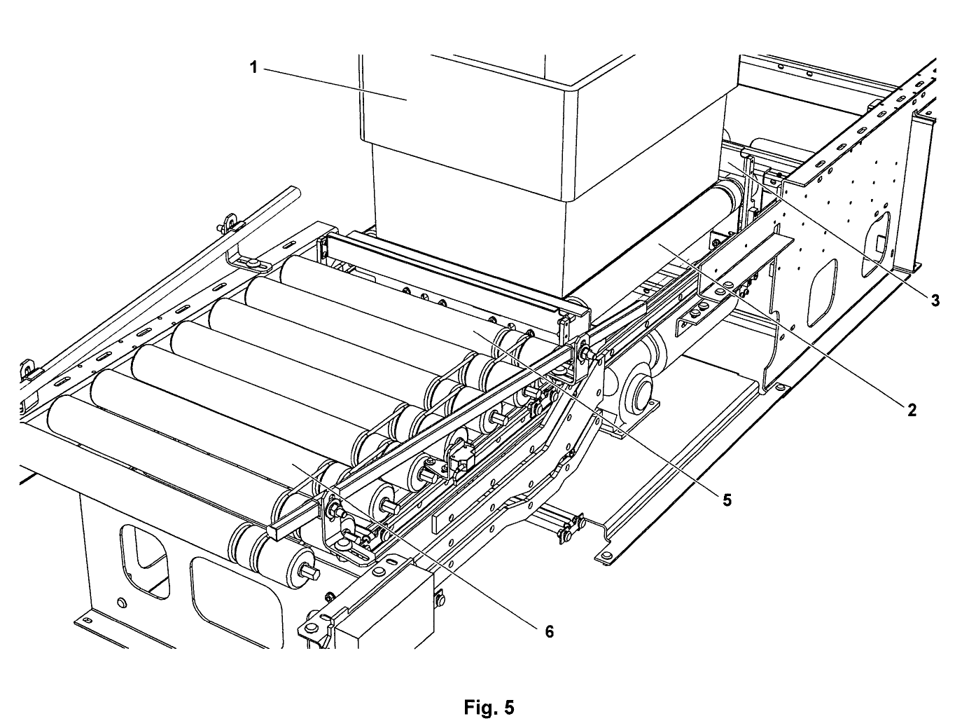

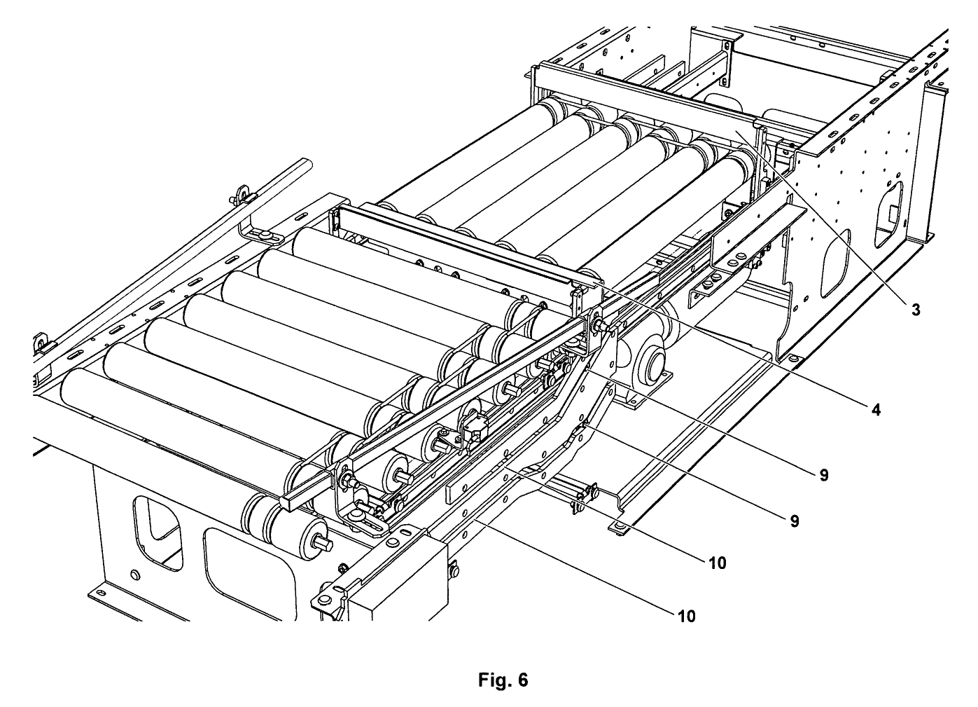

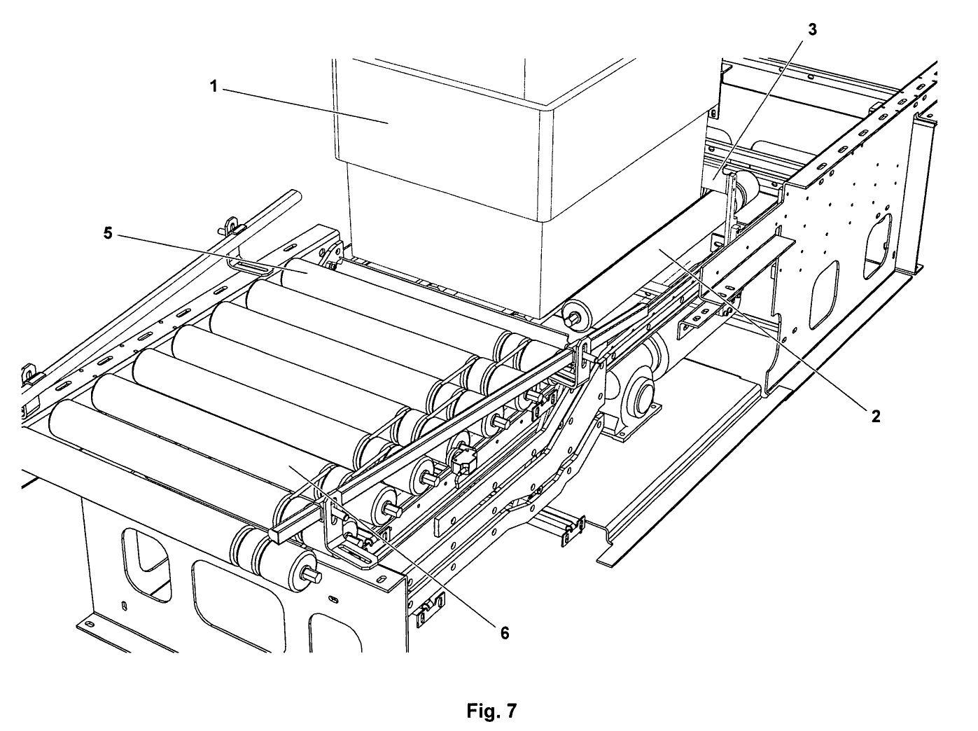

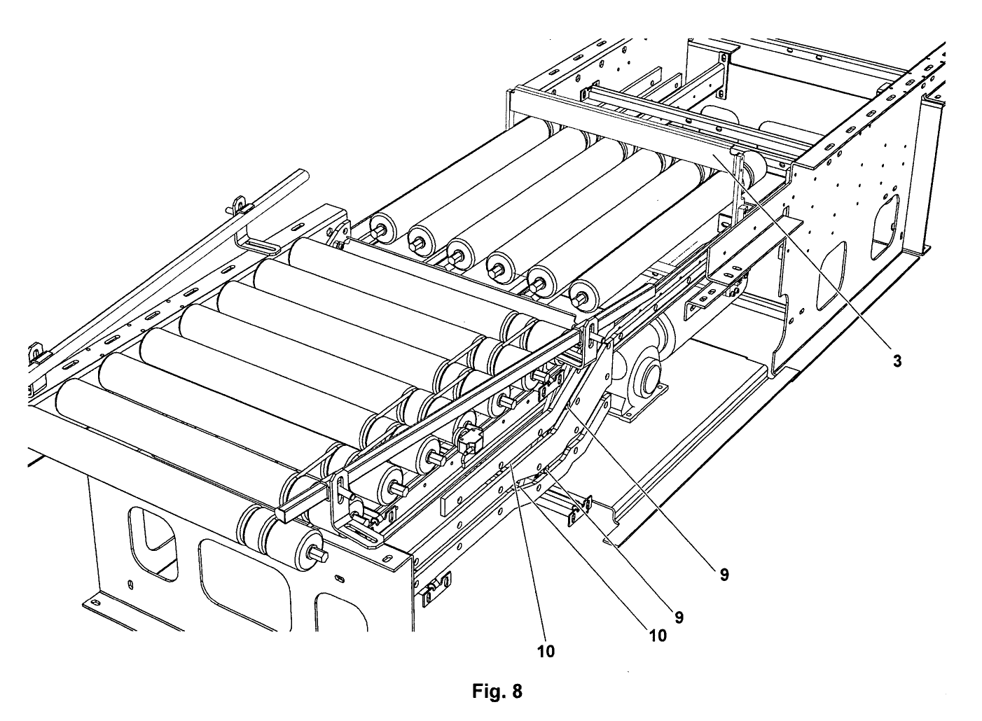

### DETAILED DESCRIPTION OF EXEMPLARY EMBODIMENTS

As mentioned above, the invention comprises several different systems that can incorporate an object sorting operation, apparatus or method. In a general aspect of a particularly preferred embodiment, the divert guides move in either direction and perpendicular to the main conveyor axis to provide a pushing force to transfer a conveyed object to a side staging position. The main conveying position of the divert guides essentially defines the main axis of the conveyor system at a certain point. During a divert or transfer stroke, the divert guide on the side of the object not in forced contact with the object retracts below the surface of the conveyor and does not impede the divert or transfer action of the object. The divert guide returns to its home, the main conveyor guide position, after the transfer stroke is complete. Staged objects can be returned to the main conveyor axis using the same sequence and with the assistance of moving surfaces or driving rollers or an external mechanism in a staging section (divert area) of the device. These driving rollers or external mechanisms force the object against the receiving divert guide and back toward the main conveyor axis, until the retracted guide returns to its starting height capturing the transferred unit between both side guides on the return stroke. The operation advantageously maintains the object substantially in the center of the conveying surfaces and/or ensures that the object is not partially outside the main conveyor surface.

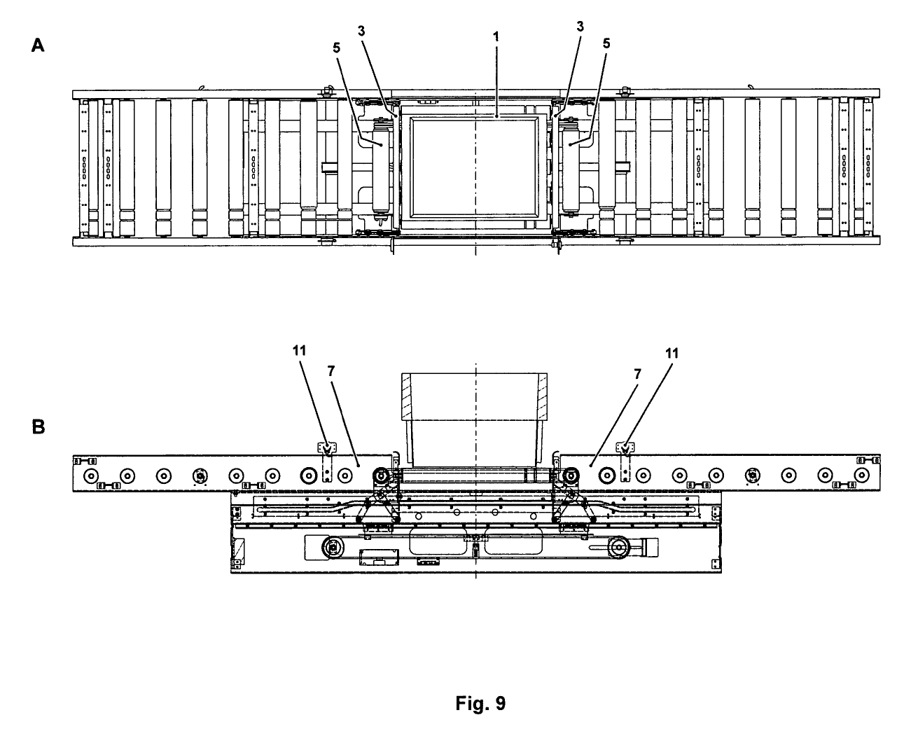

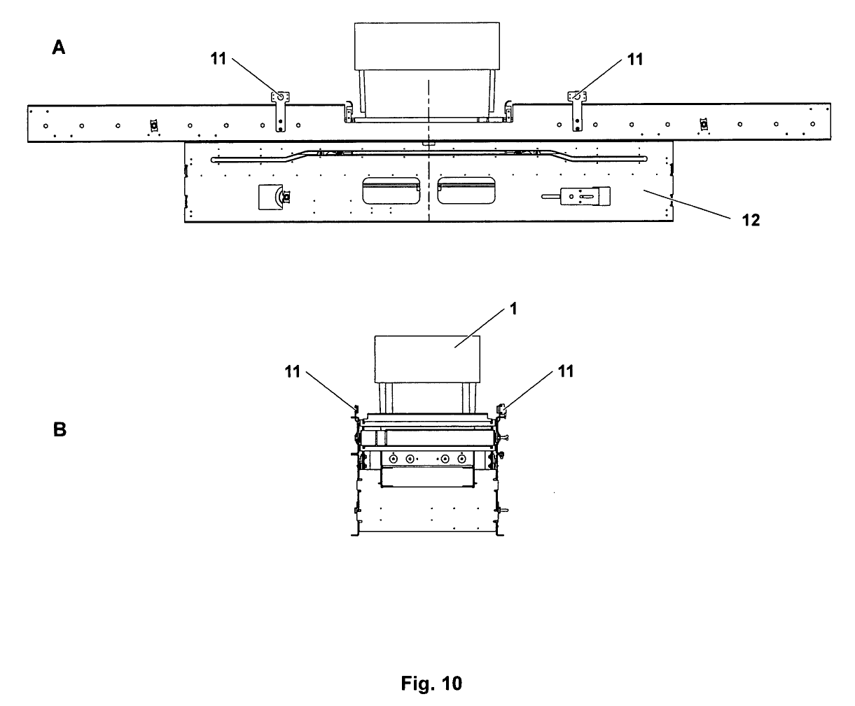

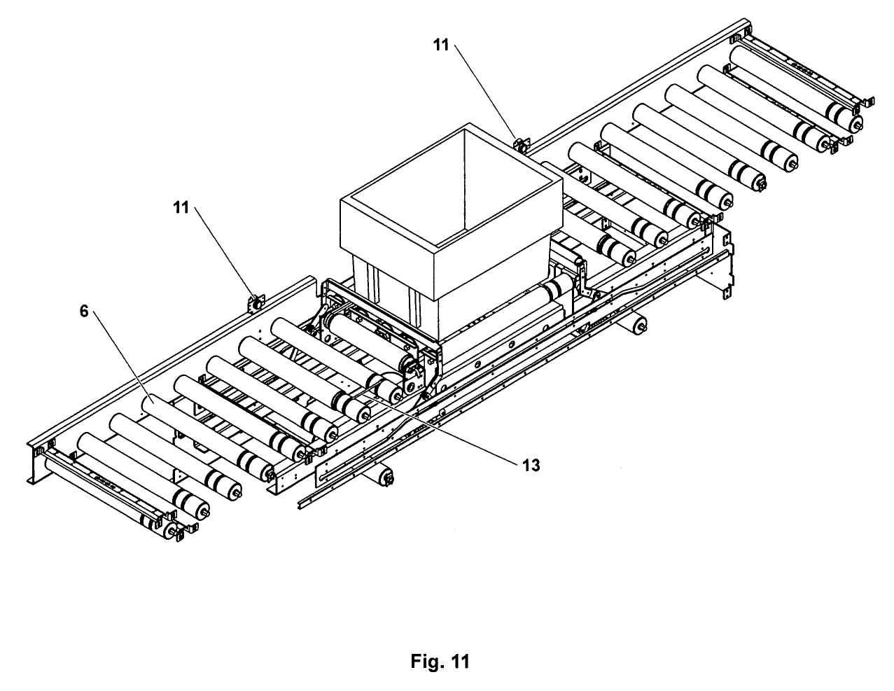

As in other USPS mail sorting apparatus, the conveyance of trays or objects is along a main axis of a conveyor line, while the invention specially provides a method and device to transfer any tray or object to or from a divert area (staging section) adjacent to the main conveyor axis and while maintaining the side guard aspects of the main conveyor. In certain ways of employing the invention in a conveying system for sorting mail trays, the trays have a sort label or more particularly a bar code, which determines the delivery site of the trays and/or which informs one of where the tray is to be delivered, shipped, or of the delivery site for the tray. The main roller conveyor for moving mail trays along a conveying path includes at least two lateral divert areas or staging stations, one on each side of the main conveyor path. In one aspect, the invention provides an improvement in the use of the divert areas or staging stations through a new bi-directional divert apparatus, which can be employed to push trays in an improved manner into the divert areas. A master control computer, operating based upon information on a bar code or sort label on a tray, stops the movement of the tray, and activates the divert guides of the bi-directional divert apparatus. This laterally diverts the mail tray out of the conveyor path and into a divert area generally at a right angle to the conveyor path. The invention specifically refers to a divert guide, or retractable divert guides (for example parts (3) and (4) in the Figures), which is/are housed under the main conveyor at least part of the time. The divert guides provide the force to move trays to the left or to the right of the main conveyor path. The divert point will generally include rollers or motorized rollers (2) that can move the tray in the main conveyor path. Other methods or motorized surfaces can be used in place of rollers in this and any other aspect of the invention. The divert guides can be incorporated into a pusher assembly and positioned in such a way that the divert guides protrude up at the side of the main conveyor path at the divert point, and can one at a time traverse over all or a part of the main conveyor path at the divert point to push a tray. One or more wheels and wheel tracks can be used to allow the pusher assembly to coordinate the movement of the divert guides on either side of the main conveyor path so that as one side pushes a tray into a divert area, the other side retracts under the path of the tray. Thus, the divert guides on each side are connected through the assembly to act in concert and to avoid interfering with or jamming the divert process. One of skill in the art is familiar with mechanical devices and available wheels and track systems to accomplish the function of the pusher assembly, and an exemplary system is shown in FIG. 9B. While the pusher assembly is shown to be housed below the conveyor in the Figures, embodiments can be devised where the divert guides operate from above the trays. Motors, drives, and other actuating devices can be combined with the pusher assembly in order to make the divert action respond to a master control computer at a certain time point or at a certain signal.

A controller can also be used to maintain motor speed of the rollers of conveying surfaces or the divert area rollers or surfaces. Different speeds may be desired at different point in the divert and return process.

As in other examples of the art, the rollers used can be operably linked by belts or chains and set at a tension to control the movement on the conveying surfaces.

A controlling device can also be used to assist in stopping a tray in a known, repeatable area on the divert point so that a tray can be diverted accurately. One of skill in the art is familiar with computer control methods for detecting the point at which a tray is located, as well as other mechanical methods, such as stop devices, to accurately locate a tray.

The divert process, as noted above, can be controlled through sensors and control logic. Electrooptic, infrared, or other types of sensors located on the conveyor and divert area can be used. Sensors are shown in exemplary areas in the Figures, but other areas can contain sensors. One function of the sensors is to communicate location information to a master control computer. In addition, proximity sensors can be used to confirm that the divert function as a whole is operating normally, and/or that the appropriate parts of the pusher assembly are being deployed, for example. The control logic to be used is known to one of skill in the art and can be selected from any available.

Throughout this disclosure, applicants may refer to texts and other sources of information. One skilled in the art can use the entire contents of any of the cited sources of information to make and use aspects of this invention. Each and every cited source of information is specifically incorporated herein by reference in its entirety. Portions of these sources may be included in this document as allowed or required. However, the meaning of any term or phrase specifically defined or explained in this disclosure shall not be modified by the content of any of the sources. The description and examples are merely exemplary of the scope of this invention and content of this disclosure and do not limit the scope of the invention. In fact, one skilled in the art can devise and construct numerous modifications to the examples listed below without departing from the scope of this invention.

What is claimed is:

1. A conveyor system for sorting mail trays, wherein the trays have a sort label for a desired delivery site or sorting area, comprising a conveyor having a plurality of rollers for moving trays along a conveying axis or path that is formed by the conveyor rollers, and one or more bi-directional lateral divert apparatus capable of being combined or linked with the conveying axis or path and the rollers of the axis or path, the bi-directional lateral divert apparatus comprising:
divert areas on each side of the conveyor axis or path, wherein the divert areas have rollers or moving receivers for receiving a diverted tray from the conveyor axis or path depending upon the information on the sort label;
retractable divert guides on either side of the conveyor axis or path and capable of pushing a tray toward or into a desired area, the divert guides disposed or operating so that as at least one divert guide initially on one side of the conveyor axis or path pushes the tray, the divert guide or guides on the other side of the conveyor axis or path retract under the rollers of the conveyor axis or path to allow the tray to traverse into a divert area; and
return rollers or movers in the divert area to return the tray to the conveyor axis or path,
wherein the divert guides function to push the tray in substantially the center of the divert area and function to position the tray being returned to the conveyor axis or path in substantially the center of the conveyor axis or path.

2. The conveyor system of claim 1, wherein a plurality of bi-directional lateral divert apparatus are used.

3. The conveyor system of claim 1, wherein the retractable divert guides on either side of the conveyor axis or path are disposed to retract under one side or the other of the conveyor axis or path and return to a conveying position wherein the divert guides are on either side of the conveyor axis or path.

4. The conveyor system of claim 3, wherein a plurality of bi-directional lateral divert apparatus are used.

5. The conveyor system of claim 1, wherein a sensor is used to detect the position of a tray on the conveyor axis or path.

6. The conveyor system of claim 3, wherein a sensor is used to detect the position of a tray on the divert area.

7. The conveyor system of claim 5, wherein a master control computer is used to determine whether a tray contains a sort label for a desired divert area, and wherein the master control computer is operably connected to the motors for controlling the conveyor axis or path rollers and bi-directional lateral divert apparatus.

8. A method for sorting mail trays comprising diverting a desired tray from a conveyor axis or path by one or more bi-directional lateral divert apparatus, wherein the bi-directional lateral divert apparatus comprises:
divert areas on each side of the conveyor axis or path, wherein the divert areas have rollers or moving receivers for receiving a diverted tray from the conveyor axis or path depending upon the information on the sort label;
retractable divert guides on either side of the conveyor axis or path and capable of pushing a tray toward or into a desired area, the divert guides disposed or operating so that as at least one divert guide initially on one side of the conveyor axis or path pushes the tray, the divert guide or guides on the other side of the conveyor axis or path retract under the rollers of the conveyor axis or path to allow the tray to traverse into a divert area; and
return rollers or motors in the divert area to return the tray to the conveyor axis or path,
wherein the divert guides function to push the tray in substantially the center of the divert area and function to position the tray being returned to the conveyor axis or path in substantially the center of the conveyor axis or path.

9. The method of claim 8, wherein the method is capable of processing approximately 40,000 pieces of mail per hour, or 1,600 mail trays per hour.

10. The method of claim 8, wherein the sort label comprises a bar code readable by a photoelectric sensor.

11. The method of claim 8, wherein a plurality of trays are sorted into a desired sequence on the conveyor axis.

12. The method of claim 8, wherein a plurality of trays are sorted into desired divert areas.

13. An apparatus for sorting objects comprising:
a main conveyor for moving objects along a conveyance axis;
a lateral diverter for moving objects out of the conveyance axis, wherein the lateral diverter rests at a divert point on the conveyance axis;
a divert area for receiving the object once it is out of the conveyance axis, wherein the divert area can comprise an area on one or both lateral sides of the conveyance axis;
retractable guides disposable on either side of the divert point to direct the object into a divert area; and
a return actuator for returning the object to the main conveyor.

14. The apparatus of claim 13, wherein the main conveyor is formed to accept mail trays from a conveyor line of a mail distribution center.

15. The apparatus of claim 13, wherein the retractable guides function to push the tray in substantially the center of the divert area and function to position the tray being returned to the main conveyor in substantially the center.

16. The apparatus of claim 15, wherein one retractable guide is capable of being positioned above the plane of rollers of the main conveyor while a second retractable guide remains below the plane of rollers of the main conveyor.

17. The apparatus of claim 13, wherein multiple divert areas are capable of acting as staging areas for the temporary storage of objects during the operation of one or more sorting processes.

18. The apparatus of claim 17, wherein at least one divert area is located on each end of a main conveyor, where the main conveyor has a first and second end.

19. The apparatus of claim 18, wherein one end of the main conveyor is a dispatch end where objects can be removed from the main conveyor after a sorting process.
